(19) United States
(12) Patent Application Publication
(10) Pub. No.: US 2026/0240133 A1
(43) Pub. Date: Aug. 20, 2026

(54) FIXING STRUCTURE OF FISHING LINE GUIDE AND FISHING ROD

(71) Applicant: GLOBERIDE, Inc., Tokyo (JP)

(72) Inventors: Naohiro YAMADA, Higashikurume-shi (JP); Hirokazu YAMAMOTO, Higashikurume-shi (JP)

(73) Assignee: GLOBERIDE, Inc., Tokyo (JP)

(21) Appl. No.: 19/420,952

(22) Filed: Dec. 16, 2025

(30) Foreign Application Priority Data
Feb. 20, 2025 (JP) 2025-025855

(51) Int. Cl. A01K 87/04

(52) U.S. Cl. CPC A01K 87/04

(57) ABSTRACT

A fixing structure of a fishing line guide according to an embodiment of the present invention comprising: a ring holding portion that holds a guide ring through which a fishing line is inserted and guided; and a leg portion that extends from the ring holding portion and is fixed to an outer surface of a fishing rod, the fixing structure comprises: a first primer layer applied to an outer surface of a rod body of the fishing rod; a lower line winding layer wound on the first primer layer; the leg portion that is a fixed member arranged on the lower line winding layer; and an upper line winding layer wound on the leg portion that is the fixed member.

### CROSS-REFERENCE TO RELATED APPLICATION

This application claims priority under 35 U.S.C. § 119 to Japanese Patent Application No. 2025-025855 filed on February 20, 2025 in the Japanese Patent Office, the entire contents of each hereby incorporated by reference.

### BACKGROUND OF THE INVENTION

### 1. TECHNICAL FIELD

The present invention relates to a fixing structure of a fishing line guide which is fixed to a rod body outer surface of a fishing rod and is for guiding a fishing line, and a fishing rod having such a fixing structure.

### 2. DESCRIPTION OF THE RELATED ART

Conventionally, as a fishing line guide for guiding a fishing line to a fishing rod, various fishing line guides in which a guide ring is fitted into a through-hole of the fishing line guide are known. There is a possibility that such a fishing line guide fixed to a fishing rod may be detached from the fishing rod if the strength against the tensile force in the rod distal end direction is not sufficient, and various fixing structures of the fishing line guide have been proposed in which the fishing line guide is hardly removed and the fishing line guide has strength enough to withstand the load.

In relation to such a fixing structure of a fishing rod guide, for example, JP 5252688 A discloses a fishing rod in which a lower winding layer around which a hard lower winding line is wound is formed at an attachment scheduled location of an auxiliary tool for fishing operation on an outer peripheral surface of a rod body, a leg portion of the auxiliary tool for fishing operation is placed on the wound lower winding line, and an attachment fixing layer around which the leg portion is attached and fixed is formed by winding an attachment line softer than the lower winding line over the leg portion and the lower winding line wound around the outer peripheral surface of the rod body.

In addition, JP 2000-236783 A discloses a fishing rod in which a guide body including a guide leg portion made of metal, a frame portion formed integrally with the guide leg portion, and a guide ring fixed to the frame portion is attached on a rod tube, wherein a vibration-proof layer made of a two-liquid reaction type urethane-based ink is provided on an outer periphery of

the guide leg portion. Furthermore, JP 2000-189009 A discloses a fishing rod in which a guide body including a guide ring fixing portion and a guide leg portion is attached onto a rod tube of a fishing rod, in which a lower line layer for stably placing the guide leg portion is formed on the rod tube, a guide leg portion is placed on the lower line layer, an upper line layer for fixing the guide leg portion is formed from above the guide leg portion to above the lower line layer, a line in which an outer diameter of a line of the upper line layer is larger than an outer diameter of a line of the lower line layer is used, and the lower line layer and the upper line layer are covered with a synthetic resin material.

### SUMMARY OF THE INVENTION

However, in any aspect of JP 5252688 A, JP 2000-236783 A, and JP 2000-189009 A, it cannot be said that the fixing force of the fishing line guide to the fishing rod is necessarily sufficient, and there is a problem that the fishing line guide is detached from the fishing rod when a load of a certain level or more acts. This is particularly noticeable when the fishing line guide is fixed to the tip of the metal.

The present invention has been made in view of the above circumstances, and an object thereof is to provide a fixing structure of a fishing line guide capable of further improving a fixing force of the fishing line guide to a fishing rod, making it difficult for the fishing line guide to be detached from the fishing rod during actual fishing, and more reliably and stably exhibiting a function of the fishing line guide, and a fishing rod comprising a fishing line guide having such a fixing structure. Other objects of the present invention will become apparent by reference to the entire specification.

A fixing structure of a fishing line guide according to an embodiment of the present invention comprising: a ring holding portion that holds a guide ring through which a fishing line is inserted and guided; and a leg portion that extends from the ring holding portion and is fixed to an outer surface of a fishing rod, the fixing structure comprises: a first primer layer applied to an outer surface of a rod body of the fishing rod; a lower line winding layer wound on the first primer layer; the leg portion that is a fixed member arranged on the lower line winding layer; and an upper line winding layer wound on the leg portion that is the fixed member.

In the fixing structure of the fishing line guide according to an embodiment of the present invention, the first primer layer is configured to have a granular body.

In the fixing structure of the fishing line guide according to an embodiment of the present invention, the granular body is configured to be exposed on the surface of the first primer layer.

In the fixing structure of the fishing line guide according to an embodiment of the

present invention, the particle size of the granular body is configured to be larger than the thickness of the first primer layer.

The fixing structure of the fishing line guide according to an embodiment of the present invention is configured to comprise a second primer layer applied on the upper line winding layer.

The fixing structure of the fishing line guide according to an embodiment of the present invention comprises a line stopper agent layer on the second primer layer, and is configured such that viscosity of the first primer layer and the second primer layer is higher than the viscosity of the line stopper agent layer.

In the fixing structure of the fishing line guide according to an embodiment of the present invention, the lower line winding layer and the upper line winding layer are continuously wound with the same line.

A fishing rod according to an embodiment of the present invention comprises a rod body, a fishing line guide, and any of the above-described fixing structures of the fishing line guides.

In the fishing rod according to an embodiment of the present invention, the rod body is formed of a metal material.

According to the above embodiment, it is possible to provide the fixing structure of the fishing line guide capable of further improving the fixing force of the fishing line guide to the fishing rod, making it difficult for the fishing line guide to be detached from the fishing rod during actual fishing, and more reliably and stably exhibiting the function of the fishing line guide, and the fishing rod comprising the fishing line guide having such a fixing structure.

### BRIEF DESCRIPTION OF THE DRAWINGS

FIG. 1 is a view illustrating a fishing rod according to an embodiment of the present invention;

FIG. 2 is a view for describing a fixing structure 100 of a fishing line guide 10 according to an embodiment of the present invention;

FIG. 3 is a view for describing a fixing structure 100 of a fishing line guide 10 according to an embodiment of the present invention;

FIG. 4 is a view for describing a fixing structure 100 of a fishing line guide 10 according to an embodiment of the present invention;

FIG. 5 is a view for describing a fixing structure 100 of a fishing line guide 10 according to an embodiment of the present invention; and

FIG. 6 is a conceptual view for describing each layer in the fixing structure 100 of the

fishing line guide 10 according to an embodiment of the present invention.

### DETAILED DESCRIPTION

Hereinafter, an embodiment of a fixing structure of a fishing line guide according to the present invention and a fishing rod comprising the same will be specifically described with reference to the accompanying drawings. Components that are common in a plurality of drawings are denoted by the same reference signs throughout the plurality of drawings. It should be noted that each of the drawings is not necessarily drawn to an accurate scale for convenience of description.

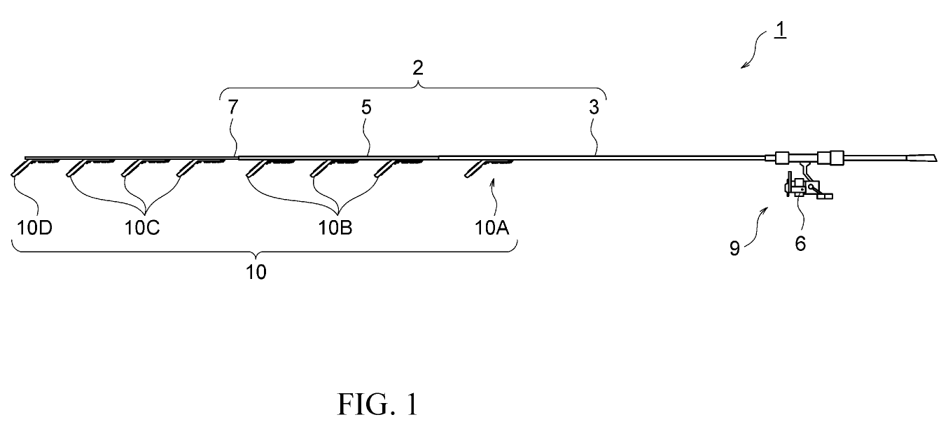

FIG. 1 is a view illustrating an embodiment of a fishing rod according to the present invention. As illustrated in the drawing, a fishing rod 1 according to an embodiment of the present invention comprises a rod body 2, a fishing reel 6 attached to the rod body 2 via a fishing rod reel seat 9, and a fishing line guide 10 attached to the rod body 2. In the illustrated embodiment, each of the fishing rod reel seat 9 and the fishing line guide 10 corresponds to an attachment component attached to the outer peripheral surface of the rod body.

The rod body 2 is formed by, for example, connecting a base rod 3, a middle rod 5, a tip rod 7, and the like to each other. These rod bodies are joined by an ordinarily jointed type, an inversely jointed type, or a socket-and-spigot jointed type as described later.

Each of the base rod 3, the middle rod 5, and the tip rod 7 is formed by, for example, a tubular body made of a fiber-reinforced resin. This tubular body made of the fiber-reinforced resin is produced by winding a fiber-reinforced resin prepreg (prepreg sheet) obtained by impregnating reinforcing fibers with a matrix resin around a core metal, and heating and curing the prepreg sheet. As the reinforcing fibers contained in the prepreg sheet, for example, carbon fibers, glass fibers, and any other known reinforcing fibers can be used. As the matrix resin contained in the prepreg sheet, a thermosetting resin such as an epoxy resin can be used. After the prepreg sheet is cured, the core metal is removed. In addition, an outer surface of the tubular body is appropriately polished. Each of the rod bodies may be formed in a solid state.

In the illustrated embodiment, a plurality of fishing line guides 10 (fishing line guides 10A to 10D) for guiding a fishing line unreeled from the reel 6 attached to the fishing rod reel seat 9 is fixed to the base rod 3, the middle rod 5, and the tip rod 7 by a fixing structure of the fishing line guide to be described later. More specifically, the base rod 3 is provided with a fishing line guide 10A, the middle rod 5 is provided with a fishing line guide 10B, and the tip rod 7 is provided with a fishing line guide 10C. A top guide 10D is provided on a distal end of the tip rod 7, but this is not described in detail. Here, as a material of the fishing line guide 10, metal, resin, or fiber-reinforced resin can be usually used, but the present invention is not limited thereto. In addition, the metal is usually considered as a material of a guide ring, but ceramics (SiC or the like) or other materials may be used. Hereinafter, details of a fixing structure of a fishing line guide according to an embodiment of the present invention will be described.

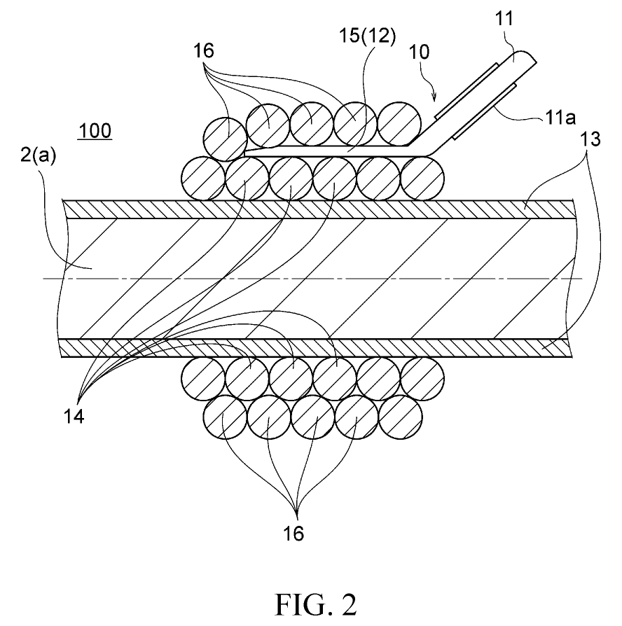

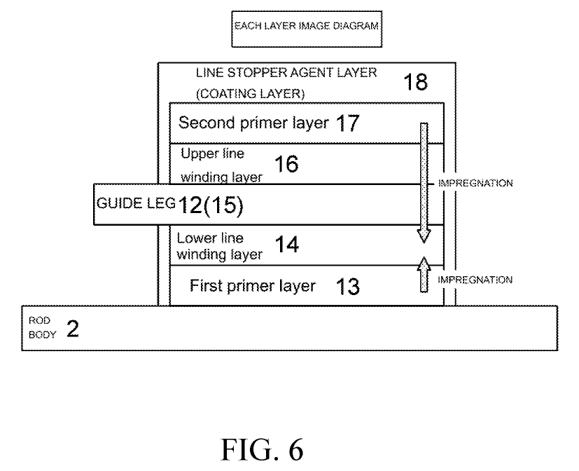

A fishing line guide according to an embodiment of the present invention will be described with reference to FIGS. 2 to 6. FIGS. 2, 3, 4, and 5 are views for describing the fixing structure 100 of the fishing line guide 10 according to an embodiment of the present invention. In addition, FIG. 6 is a conceptual view for describing each layer in the fixing structure 100 of the fishing line guide 10 according to an embodiment of the present invention. Here, for convenience of description, it is additionally noted that the scale of each member in FIGS. 2 to 5 does not necessarily coincide with the actual scale.

First, as illustrated in FIG. 2, the fixing structure 100 of the fishing line guide 10 according to an embodiment of the present invention comprises a ring holding portion 11 that holds a guide ring 11a through which a fishing line is inserted and guided, and a leg portion 12 that extends from the ring holding portion 11 and is fixed to an outer surface of the rod body 2 of the fishing rod 1, and comprises a first primer layer 13 applied to an outer surface of the rod body 2 of the fishing rod 1, a lower line winding layer 14 wound on the first primer layer 13, the leg portion 12 that is a fixed member 15 arranged on the lower line winding layer 14, and an upper line winding layer 16 wound on the leg portion 12 that is the fixed member 15. Here, the first primer layer 13 refers to an underlayer. Note that the member fixed to the rod body 2 of the fishing rod 1 is not limited to the fishing line guide, and for example, a plate seat (plate-shaped reel seat), a needle hook, a fixing member of a tail rope, and the like can be considered. In addition, as the line used for each line winding layer, for example, a line of a material such as nylon, silk, polyester, or acrylic is used.

According to the fixing structure 100 of the fishing line guide 10 according to an embodiment of the present invention, it is possible to provide the fixing structure of the fishing line guide capable of further improving the fixing force of the fishing line guide to the fishing rod, making it difficult for the fishing line guide to be detached from the fishing rod during actual fishing, and more reliably and stably exhibiting the function of the fishing line guide. In particular, by providing (interposing) the primer layer having elastic force on the outer surface of the rod body of the fishing rod, the lower line winding layer conforms to the rod body of the fishing rod, so that the tension when fixing the lower line winding layer to the rod body of the fishing rod can be increased, and the fixing force of the fishing line guide to the rod body of the fishing rod can be improved.

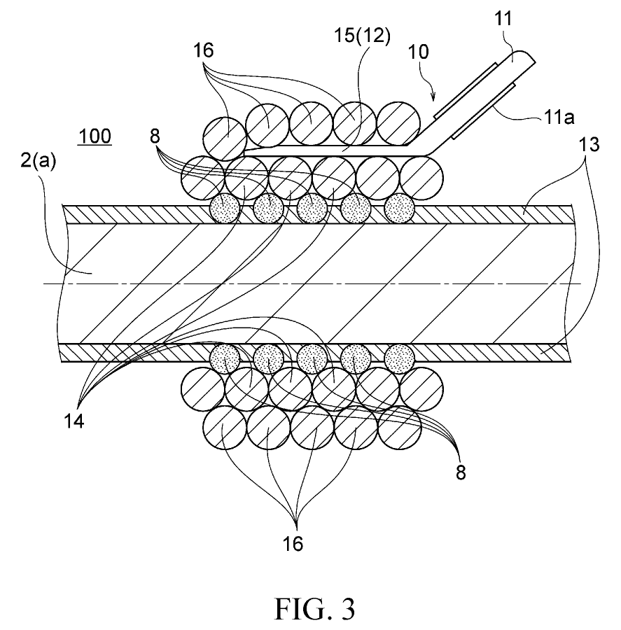

In addition, as illustrated in FIG. 3, in the fixing structure 100 of the fishing line guide 10 according to an embodiment of the present invention, the first primer layer 13 is configured to have a granular body 8. Here, as the granular body, for example, glass beads, sand, plastic, ceramic, and organic media (bamboos, walnut shells, pieces of wood, etc.) are used. In this manner, with the fixing structure 100 of the fishing line guide 10 according to an embodiment of the present invention, the line of the lower line winding layer 14 can be hooked on and wound around the granular body 8 formed in the first primer layer 13, and thus, the winding can be performed with a higher tension, so that the fixing force of the fishing line guide 10 to the rod body 2 of the fishing rod 1 can be further improved.

Similarly, as illustrated in FIG. 3, in the fixing structure 100 of the fishing line guide 10 according to an embodiment of the present invention, the granular body 8 is configured to be exposed on the surface of the first primer layer 13. In this manner, with the fixing structure 100 of the fishing line guide 10 according to an embodiment of the present invention, the line of the lower line winding layer 14 can be hooked on and wound around the granular body 8 formed in the first primer layer 13, and thus, the winding can be performed with a higher tension, so that the fixing force of the fishing line guide 10 to the rod body 2 of the fishing rod 1 can be further improved.

Similarly, as illustrated in FIG. 3, in the fixing structure 100 of the fishing line guide 10 according to an embodiment of the present invention, the particle size of the granular body 8 is configured to be larger than the thickness of the first primer layer 13. Here, the thickness of the first primer layer 13 is, for example, a thickness in a range of 10 μm to 20 μm, and the particle size of the granular body 8 is, for example, a size of 100 μm. In this manner, with the fixing structure 100 of the fishing line guide 10 according to an embodiment of the present invention, the granular body 8 is easily exposed from the first primer layer 13 and the line of the lower line winding layer 14 can be hooked on and wound around the granular bodies 8. Therefore, the winding can be performed with a higher tension, and the fixing force of the fishing line guide 10 to the rod body 2 of the fishing rod 1 can be further improved.

In the fixing structure 100 of the fishing line guide 10 according to an embodiment of the present invention, the attachment ratio (attachment area) of the granular body 8 formed in the first primer layer 13 is preferably 50% or more with respect to the surface area of the first primer layer. In addition, in the fixing structure 100 of the fishing line guide 10 according to an embodiment of the present invention, the attachment range of the granular body 8 formed in the first primer layer 13 is preferably formed over a range of at least 1 mm from the line winding start point of the lower line winding layer 14 (in the direction in which the line is wound (extending direction of the leg portion 12)), and the attachment ratio (attachment area) of the granular body 8 formed in the first primer layer 13 is preferably 50% or more with respect to the surface area of the first primer layer. In addition, in the fixing structure 100 of the fishing line guide 10 according to an embodiment of the present invention, it is more preferable that the granular body 8 is provided so as to be exposed from the first primer layer 13 by 50% or more of the height of the granular body as viewed in the thickness direction of the first primer layer 13. In addition, it is preferable that the second primer impregnated from a second primer layer 17 to be described later is provided in a space between the first primer layer 13 and the lower line winding layer 14, where the granular body 8 is not provided, so as to be scattered at a position where the granular body 8 is not provided in such a space of 1 μm or more in thickness. In this manner, the fixing structure 100 of the fishing line guide 10 according to an embodiment of the present invention can further improve the fixing force of the fishing line guide 10 to the rod body 2 of the fishing rod 1.

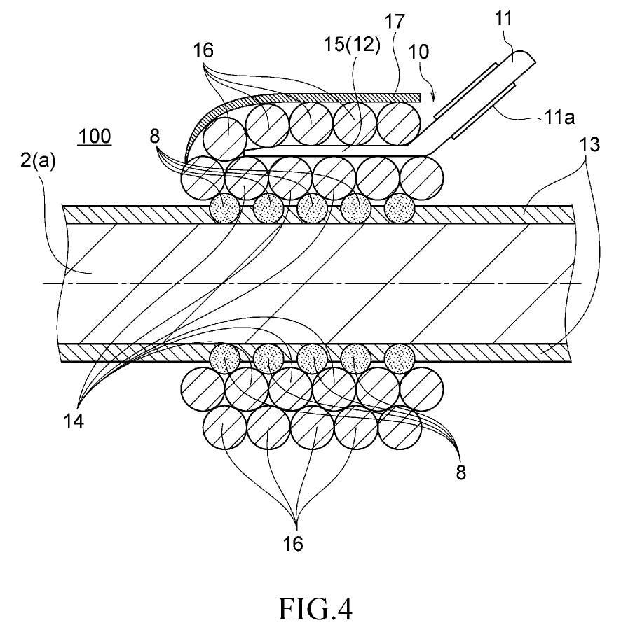

Next, as illustrated in FIG. 4, the fixing structure 100 of the fishing line guide 10 according to an embodiment of the present invention is configured to comprise the second primer layer 17 applied on the upper line winding layer 16. Here, the second primer layer 17 refers to an impregnated layer. According to the fixing structure 100 of the fishing line guide 10 according to an embodiment of the present invention, the first primer (for example, epoxy resin) from the first primer layer 13 and the second primer (for example, epoxy resin) from the second primer layer 17 are easily impregnated into the line of the upper line winding layer 16 and the line of the lower line winding layer 14, and thus the fishing line can be wound with a higher tension. Therefore, the fixing force of the fishing line guide 10 to the rod body 2 of the fishing rod 1 can be further improved. In particular, in the configuration in which the first primer layer 13 comprises the granular body 8, the second primer is easily impregnated into the gap between the lower line winding layer 14 formed by the granular body 8 and the first primer layer 13, and the effect of more remarkable improvement of the fixing force is obtained.

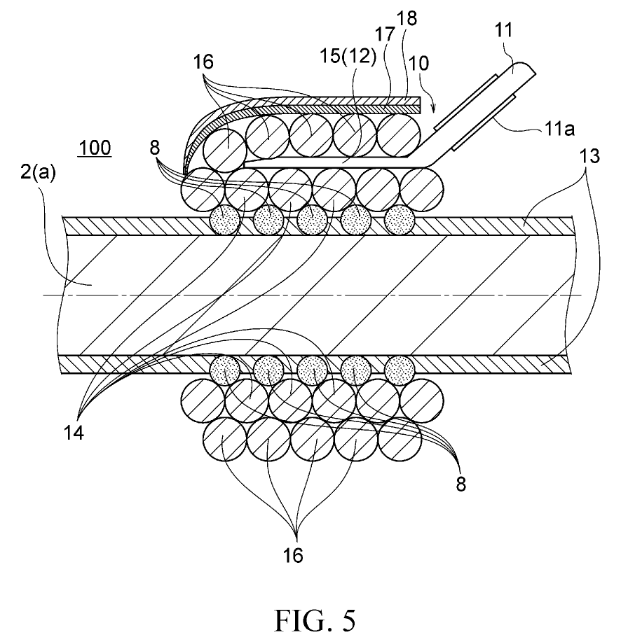

As illustrated in FIGS. 5 and 6, the fixing structure 100 of the fishing line guide 10 according to an embodiment of the present invention comprises the line stopper agent layer 18 on the second primer layer 17, and the first primer layer 13 and the second primer layer 17 are configured to have viscosity higher than the viscosity of the line stopper agent layer 18. Here, for example, an epoxy resin, a UV material, and the like can be used for the line stopper agent layer 18. According to the fixing structure 100 of the fishing line guide 10 according to an embodiment of the present invention, the first primer (for example, epoxy resin) from the first primer layer 13 and the second primer (for example, epoxy resin) from the second primer layer 17 are easily impregnated into the line of the upper line winding layer 16 and the line of the lower line winding layer 14, and thus the fishing line can be wound with a higher tension. Therefore, the fixing force of the fishing line guide 10 to the rod body 2 of the fishing rod 1 can be further improved.

In addition, in the fixing structure 100 of the fishing line guide 10 according to an embodiment of the present invention, the lower line winding layer 14 and the upper line winding layer 16 are continuously wound with the same line. In this manner, since the shift of the upper line winding layer 16 with respect to the lower line winding layer 14 can be effectively suppressed, the tension by the line of the upper line winding layer 16 can be further increased, leading to further improvement of the fixing force.

The fishing rod 1 according to an embodiment of the present invention is configured to comprise the rod body 2, the fishing line guide 10, and any of the above-described fixing structures 100 of the fishing line guides 10. According to the fishing rod 1 according to an embodiment of the present invention, it is possible to provide a fishing rod having a fixing structure of a fishing line guide capable of further improving a fixing force of the fishing line guide to the fishing rod, making it difficult for the fishing line guide to be detached from the fishing rod during actual fishing, and more reliably and stably exhibiting a function of the fishing line guide. In particular, by providing (interposing) the primer layer having elastic force on the outer surface of the rod body of the fishing rod, the lower line winding layer conforms to the rod body of the fishing rod, so that the tension when fixing the lower line winding layer to the rod body of the fishing rod can be increased, and the fixing force of the fishing line guide to the rod body of the fishing rod can be improved.

In the fishing rod 1 according to an embodiment of the present invention, the rod body 2 is formed of a metal material. As a result, it is possible to provide a fishing rod having a fixing structure of a fishing line guide capable of further improving a fixing force of the fishing line guide to the fishing rod, making it difficult for the fishing line guide to be detached from the fishing rod during actual fishing, and more reliably and stably exhibiting a function of the fishing line guide even with a rod body such as a metal tip having a weak frictional force, a small diameter, and a small contact area.

The dimension, material, and disposition of each component described in the present specification are not limited to those explicitly described in the embodiment, and each component can be modified to have any dimension, material, and disposition that are within the scope of the present invention. In addition, components not explicitly described in the present specification can also be added to the described embodiments, or some of the components described in the embodiments can be omitted.

### Reference Signs List

1 Fishing rod
2 Rod body
3 Base rod 5 Middle rod
6 Fishing reel
7 Tip rod
8 Granular body
9 Fishing rod reel seat
10 Fishing line guide
11 Ring holding portion
12 Leg portion (fixing portion)
13 First primer layer
14 Lower line winding layer
15 Fixed member
16 Upper line winding layer
17 Second primer layer
18 Line stopper agent layer

What is claimed is:

1. A fixing structure of a fishing line guide comprising: a ring holding portion that holds a guide ring through which a fishing line is inserted and guided; and a leg portion that extends from the ring holding portion and is fixed to an outer surface of a rod body of a fishing rod, the fixing structure of the fishing line guide comprising:
a first primer layer applied to an outer surface of the rod body of the fishing rod;
a lower line winding layer wound on the first primer layer;
the leg portion being a fixed member arranged on the lower line winding layer; and
an upper line winding layer wound on the leg portion being the fixed member.

2. The fixing structure of the fishing line guide according to claim 1,
wherein the first primer layer has a granular body.

3. The fixing structure of the fishing line guide according to claim 2,
wherein the granular body is exposed on a surface of the first primer layer.

4. The fixing structure of the fishing line guide according to claim 2,
wherein a particle size of the granular body is larger than a thickness of the first primer layer.

5. The fixing structure of the fishing line guide according to claim 1, comprising a second primer layer applied on the upper line winding layer.

6. The fixing structure of the fishing line guide according to claim 4, comprising a line stopper agent layer on the second primer layer, wherein viscosity of the first primer layer and the second primer layer is higher than viscosity of the line stopper agent layer.

7. The fixing structure of the fishing line guide according to claim 1, wherein the lower line winding layer and the upper line winding layer are continuously wound with the same line.

8. A fishing rod comprising: a rod body; a fishing line guide; and the fixing structure of the fishing line guide according to claim 1.

9. The fishing rod according to claim 9 wherein the rod body is formed of a metal material.
